(19) United States
(12) Patent Application Publication
(10) Pub. No.: US 2012/0236679 A1
(43) Pub. Date: Sep. 20, 2012

(54) HYGIENICALLY COVERED DRINK STIRRER ASSEMBLY

(76) Inventor: Alberto Oliveira, Mineola, NY (US)

(21) Appl. No.: 13/486,212

(22) Filed: Jun. 1, 2012

Related U.S. Application Data
(63) Continuation-in-part of application No. 12/583,025, filed on Aug. 14, 2009, now Pat. No. 8,210,446.

(51) Int. Cl. B01F 13/00

(52) U.S. Cl. 366/129

(57) ABSTRACT

An assembly of hygienically-covered drink stirrers, including a container with stirrers disposed within the container and hollow sleeves removably receivable over the top portion of the stirrers. The bottom end of each of the stirrers is uncovered and the stirrers are arranged in the container with said stirrers and sleeves accessible via an openable top end of the container. One of the stirrers, having the sleeves received thereon, can be selected from the container and placed into a beverage and removal of the sleeve makes accessible a hygienically constituted stirrer end.

### CROSS-REFERENCE TO RELATED APPLICATION

This application is a continuation-in-part of U.S. patent application Ser. No. 12/583,025 filed Aug. 14, 2009, the contents of which are hereby incorporated by reference.

### BACKGROUND OF THE INVENTION

1. Field of the Invention

The invention relates to an easily removable hygienic cover for a drink stirrer or straw.

2. Brief Description of the Prior Art

Although it is known from common experience that some food handlers use disposable gloves to minimize the transmission of viruses or germs and the like, bartenders and other servers typically do not. Moreover, in restaurants and bars, the bartender or server is required to serve food and drinks, handle money, and bus dishes. Thus, there is the potential for cross-contamination between the same, and, thus the spread of germs.

Of particular concern for contamination is when serving the needs of patrons with a beverage in a drinking glass. Many times, the bartender or server selects a drink stirrer or hollow straw from a container and places it into a beverage which the patron may then use to stir their drink or sip from. As is currently the conventional practice, the stirrer or straw is gripped between the bartender's thumb and pointer finger and deposited in a beverage of a drinking glass. Even assuming the precaution of the bartender or server in using a disposable glove or through washing their hands, these precautions are inadequate because the handing of money, wiping clean the bar surface and attending to such chores, taints the bartender's fingers, and the consequence is possible contamination of the stirrer or straw.

It is known in the prior art to provide drinking straws having a cover, encasing the entire straw, a portion or the whole of which must be removed before placement in a drink. Such are disadvantageous because in the fast paced environment of a bar or restaurant, it takes valuable time for the bartender or server to remove the excess portion of the drinking straw cover before placement into the drink. Moreover, this extra step of removing the excess cover material may lead to contamination of the straw if contacted by the server's fingers when removing the cover. In addition, the excess material covering the straw leads to excess waste and may lead to the covers being strewn about the floor.

Moreover, many times drink stirrers or straws come in a bulk package and must be separated into smaller individual containers on the bar or service area, leading to contamination when touched and rearranged.

While the prior art discloses many types of straw covers, so far as is known, none of these assemblies resolve all of these problems in a simple, effective and highly advantageous manner, as in the present invention.

### SUMMARY OF THE INVENTION

It is therefore an object of the present invention to provide a novel hygienically covered drink stirrer assembly.

It is another object of the invention to provide a hygienically covered drink stirrer assembly which covers and protects the stirrer from contamination.

It is also an object of the present invention to provide a hygienically covered drink stirrer assembly which covers only a portion of the stirrer thus promoting efficiency and minimizing waste.

It is yet another object of the invention to provide a hygienically covered drink stirrer assembly having indicia or advertising imprinted thereon.

It is a further object of the invention to provide a novel hygienically covered drink stirrer assembly having a plurality of stirrers and sleeves arranged in a container and which are easily and readily removed therefrom.

Certain of the foregoing and related objects are readily attained according to the present invention by the provision of an assembly of hygienically-covered drink stirrers, comprising a container having an openable top end, a plurality of stirrers disposed within said container, each of said stirrers having a predetermined length terminating at opposite first and second ends, wherein at least a portion of each of said stirrers is uncovered; and a plurality of hollow sleeves each having at least one open end which are removably receivable over said first ends of said stirrers, said sleeves having a length which is less than said length of said stirrers, and each of said stirrers has a sleeve removably received over said first end thereof and said second end of each of said stirrers is uncovered; wherein said plurality of stirrers are arranged in said container so that said sleeves are received over said first ends thereof, said second ends of said stirrers are disposed within said container, and said first ends of said stirrers with said sleeves received thereon are accessible via said open top end of said container, whereby one of said plurality of stirrers having said sleeves received thereon can be selected from said container by grasping at least one of said sleeves received over said first ends of said stirrers and said uncovered second end of said stirrer can be placed into a beverage, while holding said sleeve received over said first end of said stirrer, and whereby removal of said sleeve in covering relation on said first end makes accessible a hygienically constituted stirrer end.

Advantageously, said plurality of sleeves have indicia imprinted thereon. In one embodiment, said plurality of sleeves each have a closed end. In an alternative embodiment, said plurality of sleeves each have two open ends. It is advantageous that said plurality of stirrers are hollow straws. Alternatively, said plurality of stirrers are solid. Preferably, said plurality of sleeves are made of a material selected from the group consisting of paper and plastic.

Certain of the foregoing and related objects are also readily attained according to the present invention by the provision of a plurality of hygienically-covered drink stirrers, comprising a plurality of stirrers, each of said stirrers having a predetermined length terminating at opposite first and second ends, wherein at least a portion of each of said stirrers is uncovered; and a plurality of hollow sleeves each having at least one open end which are removably receivable over said first ends of said stirrers, said sleeves having a length which is less than said length of said stirrers, and each of said stirrers has a sleeve removably received over said first end thereof and said second end of each of said stirrers is uncovered; wherein said plurality of sleeves are received over said first ends of said plurality of stirrers, whereby one of said plurality of stirrers having said sleeves received thereon can be selected by grasping at least one of said sleeves received over said first ends of said stirrers and said uncovered second end of said stirrer can be placed into a beverage, while holding said sleeve received over said first end of said stirrer, and whereby removal of said sleeve in covering relation on said first end makes accessible a hygienically constituted stirrer end.

Advantageously, said plurality of sleeves have indicia imprinted thereon. In one embodiment, said plurality of sleeves each have a closed end. In an alternate embodiment, said plurality of sleeves each have two open ends. It is advantageous that the plurality of stirrers are hollow straws. Alternatively, said plurality of stirrers are solid. Preferably said plurality of sleeves are made of a material selected from the group consisting of paper and plastic.

In addition, certain of the foregoing and related objects are also readily attained according to the present invention by the provision of a hygienically-covered drink stirrer, comprising a stirrer having a predetermined length terminating at an opposite first and second end, wherein at least a portion of said stirrer is uncovered; and a hollow sleeve having at least one open end which is removably receivable over said first end of said stirrer, said sleeve having a length which is less than said length of said stirrer, and said stirrer has a sleeve removably received over said first end thereof and said second end of said stirrer is uncovered; wherein said sleeve is received over said first end of said stirrer, whereby said stirrer having said sleeve received thereon can be selected by grasping said sleeve received over said first end thereof and said uncovered second end of said stirrer can be placed into a beverage, while holding said sleeve received over said first end of said stirrer, and whereby removal of said sleeve in covering relation on said first end makes accessible a hygienically constituted stirrer end.

Advantageously, said sleeve has indicia imprinted thereon. In one embodiment said sleeve has a closed end. In an alternate embodiment, said sleeve has two open ends. It is advantageous that said stirrer is a hollow straw. Alternatively, said stirrer is solid. Preferably, said sleeve is made of a material selected from the group consisting of paper and plastic.

### BRIEF DESCRIPTION OF THE DRAWINGS

The description of the invention which follows, together with the accompanying drawings should not be construed as limiting the invention to the example shown and described, because those skilled in the art to which this invention appertains will be able to devise other forms thereof.

FIG. 1 is a perspective view of a bartender making a hygienic presentation of a sip straw to a patron in accordance with the present invention;

FIG. 2 is a perspective view of the sip straw being inserted into a drink by the bartender in a hygienically safe manner, via the use of the sleeve;

FIG. 3 is a perspective view of the presented sip straw in place, preparatory to use, showing the server removing the cover by grasping only the cover and not the stirrer itself;

FIG. 4 is a perspective view of a container enclosing a plurality of sleeves and straws therein, embodying the present invention, with one of the stirrers being removed by the bartender grasping only the cover;

FIG. 5 is a perspective view of a stirrer placed in a beverage with the sleeve, having indicia thereon, being removed from the stirrer;

FIG. 6 is a perspective view of hollow straw and a sleeve having two open ends; and

FIG. 7 is a perspective view of a solid drink stirrer and sleeve having an open end and a closed end.

### DETAILED DESCRIPTION OF THE INVENTION

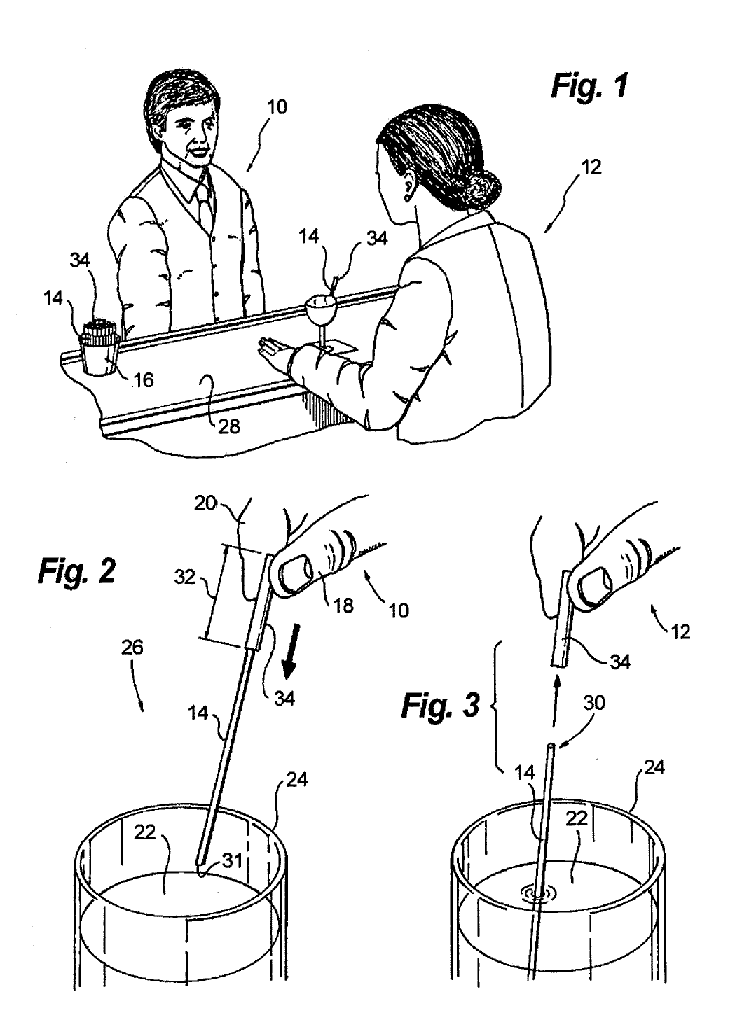

Turning now in detail to the drawings, and in particular FIG. 1, which illustrates the assembly of hygienically-covered drink stirrers, according to the present invention, comprising at least one drinker stirrer or straw 14, having a cover or sleeve 34 removably received thereon and which are received within a container 16. A stirrer 14 and sleeve 34 can be selected from container 16 located on bar surface 28 by either the bartender 10 or patron 12, by gripping only sleeve 34 which is received over stirrer 14 by the bartender's thumb 18 and pointer finger 20, and placed in a beverage 22 in a drinking glass 24, as seen in FIG. 2. Removal of sleeve 34 from stirrer 14, as seen in FIG. 3, makes accessible a hygienic drink stirrer or straw 14.

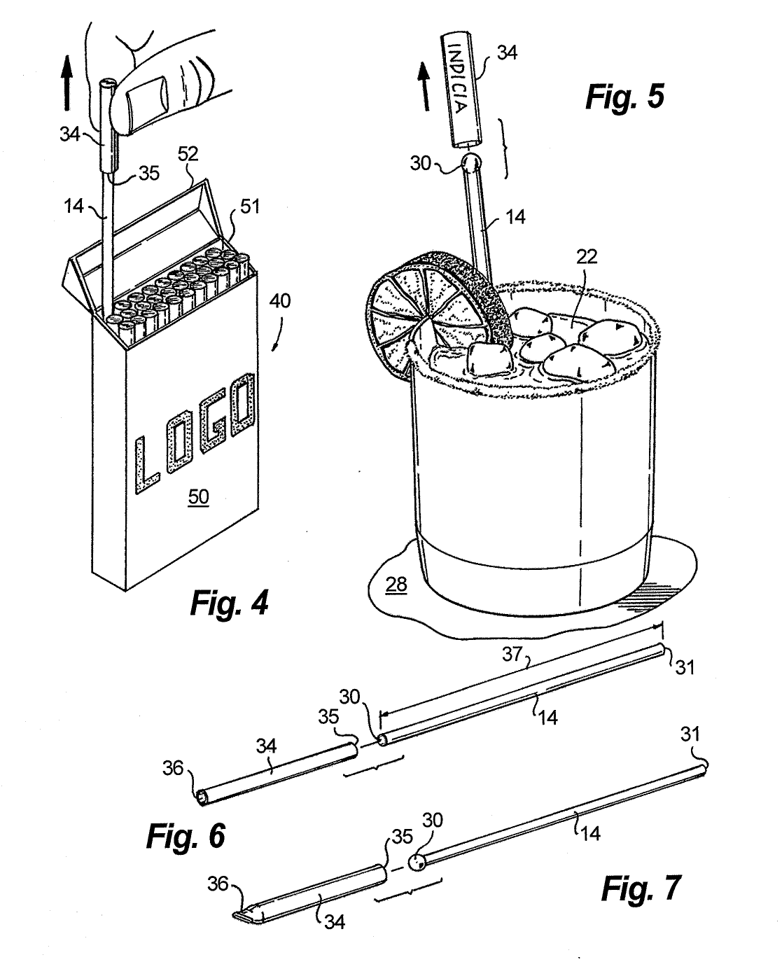

In particular, as seen best in FIG. 4, assembly 40 comprises conventional drink stirrers or sip straws 14, which are well know to those having ordinary skill in the art, and which can assume any number of shapes or configurations. Stirrer 14 can be a hollow straw as seen in FIGS. 3 and 6 or can be a drink stirrer having a solid shaft as seen in FIGS. 5 and 7. As illustrated in FIG. 6, stirrer 14 has a predetermined length 37 terminating at a first, lower end 31 which is intended to be inserted into a beverage 22 and an opposite second, upper end 30. Upper end 30 can optionally be used to sip from if the stirrer 14 is a hollow straw or, alternatively, it can be grasped to stir beverage 22.

As also seen in FIGS. 4-7, assembly 40 comprises a hollow sleeve or cover 34 having a length 32 (see FIG. 2) terminating at a first end 35 and an opposite second end 36. First end 35 of sleeve 34 is open and sleeve 34 is removably receivable over upper end 30 of stirrer 14. Particularly, sleeve 34 is received over upper end 30 of stirrer 14 via its first end 35 and overlies only an upper portion of the length 37 of stirrer 14. The length 32 of sleeve 34 is less than length 37 of stirrer 14, and arranged so that first, lower end 31 of stirrer 14 and a lower portion of the length 37 of stirrer 14 remains uncovered. Second end 36 of sleeve 34 can be open as seen in FIG. 6 or closed as seen in FIG. 7. When both ends 35 and 36 are open, sleeve 34 is retained in place over stirrer 14 preferably by a friction fit.

Furthermore, sleeve 34 can be made of a paper or a plastic material, however, other suitable materials can be utilized, as would be well known to one having ordinary skill in the art. Optionally, sleeves 34 can be imprinted with indicia such as advertising material, or company logos or names, as seen in FIG. 5. Similarly, container 50 can optionally be imprinted with indicia, as seen in FIG. 4. It is also optional that sleeve 34 have an outwardly extending flap or flag (not shown) or can assume various shapes, and/or have indicia imprinted thereon.

As illustrated in FIG. 4, in use, stirrer 14 having sleeve 34 overlying it, can be selected by grasping sleeve 34 received over upper end 30 of stirrer 14. As seen in FIG. 2, the uncovered first, lower end 31 of stirrer 14 can be placed into beverage 22, while holding only sleeve 34 while it is received over upper end 30 of stirrer 14. As seen in FIGS. 3 and 5, removal of sleeve 34 in covering relation over upper end 30 of stirrer 14 makes accessible a hygienically constituted stirrer end 30.

When in place in beverage 22, as noted in FIGS. 3 and 5, the bartender 10 or patron 12 (not shown) can remove sleeve 34 thus having a hygienic stirrer 34. Patron 12 can then optionally consume beverage 22 through the upper end 30, which is in a hygienic condition, untainted by the bartender or server 10. Alternatively, hygienic stirrer 34 can be used to stir the beverage 22.

In addition, as also seen in FIG. 4, assembly 40 optionally comprises a container 50 which has disposed within it, a plurality of stirrers 14 with sleeves 34 received thereon. Container 50 preferably has an openable top end 51 so that stirrers 14 and sleeves 34 are easily accessible therefrom. Container 50 can be a box, as seen in FIG. 4, but can alternatively assume other suitable sizes or configurations to hold various numbers of stirrers 14 and sleeves 34. The dimensions of container 50 can also vary.

Optionally, container 50 has an easily removable or openable lid or cover 52 to expose open top end 51. This allows lid 52 to be removed or opened and container 50 placed on bar surface 28, or other desired surface, without having to remove stirrers 14 and straws 34 or rearrange them into other containers 16, minimizing the potential for contamination. Particularly, container 50 can have an openable lid 52 as seen in FIG. 4. Alternatively, it can have a removable lid or tear-away top cover (not shown). However, other suitable configurations of container 50 and open top end 51 to make sleeves 34 easily accessible therefrom, are possible. Alternatively, stirrers 14 and sleeves 34 can be removed from container 50 and arranged in other containers, as desired.

A plurality of stirrers 14 are disposed within container 50 with a plurality of sleeves 34 removably received over upper ends 30 of stirrers 14, such that one or more may be easily selected, as desired. In particular, as seen in FIG. 4, a plurality of stirrers 14 are arranged in container 50 so that sleeves 34 are received over upper ends 30 of stirrers 14 and the uncovered lower ends 31 of stirrers 14 are disposed within container 50. When arranged in the manner shown in FIG. 4, upper ends 30 of stirrers 14 with sleeves 34 received thereon are accessible via open top end 51 of container 50. At least one of stirrers 14 having sleeves 34 received thereon can be selected from container 50, as seen in FIG. 4, and deposited in a beverage 22, as seen in FIG. 2. Once deposited in beverage 22, sleeve 34 may be removed, as seen in FIGS. 3 and 5.

While particular embodiments of the invention have been described, it is not intended that the invention be limited thereto, as it is intended that the invention be as broad in scope as the prior art will allow and that the specification be read likewise. It will therefore be appreciated by those skilled in the art that other modifications could be made thereto without departing from the spirit and scope of the invention. Particularly, the size of container 50 can vary to hold any number of stirrers 14 and sleeves 34 therein. In addition, the size and shape of the stirrers can vary as desired so long as the sleeve overlies and covers the top end thereof.

What is claimed is:

1. An assembly of hygienically-covered drink stirrers, comprising:
a container having an openable top end;
a plurality of stirrers disposed within said container, each of said stirrers having a predetermined length terminating at opposite first and second ends, wherein at least a portion of each of said stirrers is uncovered; and
a plurality of hollow sleeves each having at least one open end which are removably receivable over said first ends of said stirrers, said sleeves having a length which is less than said length of said stirrers, and each of said stirrers has a sleeve removably received over said first end thereof and said second end of each of said stirrers is uncovered;
wherein said plurality of stirrers are arranged in said container so that said sleeves are received over said first ends thereof, said second ends of said stirrers are disposed within said container, and said first ends of said stirrers with said sleeves received thereon are accessible via said open top end of said container, whereby one of said plurality of stirrers having said sleeves received thereon can be selected from said container by grasping at least one of said sleeves received over said first ends of said stirrers and said uncovered second end of said stirrer can be placed into a beverage, while holding said sleeve received over said first end of said stirrer, and whereby removal of said sleeve in covering relation on said first end makes accessible a hygienically constituted stirrer end.

2. The assembly according to claim 1, wherein:
said plurality of sleeves have indicia imprinted thereon.

3. The assembly according to claim 1, wherein:
said plurality of sleeves each have a closed end.

4. The assembly according to claim 1, wherein:
said plurality of sleeves each have two open ends.

5. The assembly according to claim 1, wherein:
said plurality of stirrers are hollow straws.

6. The assembly according to claim 1, wherein:
said plurality of stirrers are solid.

7. A plurality of hygienically-covered drink stirrers, comprising:
a plurality of stirrers, each of said stirrers having a predetermined length terminating at opposite first and second ends, wherein at least a portion of each of said stirrers is uncovered; and
a plurality of hollow sleeves each having at least one open end which are removably receivable over said first ends of said stirrers, said sleeves having a length which is less than said length of said stirrers, and each of said stirrers has a sleeve removably received over said first end thereof and said second end of each of said stirrers is uncovered;
wherein said plurality of sleeves are received over said first ends of said plurality of stirrers, whereby one of said plurality of stirrers having said sleeves received thereon can be selected by grasping at least one of said sleeves received over said first ends of said stirrers and said uncovered second end of said stirrer can be placed into a beverage, while holding said sleeve received over said first end of said stirrer, and whereby removal of said sleeve in covering relation on said first end makes accessible a hygienically constituted stirrer end.

8. The stirrers according to claim 7, wherein:
said plurality of sleeves have indicia imprinted thereon.

9. The stirrers according to claim 7, wherein:
said plurality of sleeves each have a closed end.

10. The stirrers according to claim 7, wherein:
said plurality of sleeves each have two open ends.

11. The stirrers according to claim 7, wherein:
said plurality of stirrers are hollow straws.

12. The stirrers according to claim 7, wherein:
said plurality of stirrers are solid.

13. A hygienically-covered drink stirrer, comprising:
a stirrer having a predetermined length terminating at an opposite first and second end, wherein at least a portion of said stirrer is uncovered; and
a hollow sleeve having at least one open end which is removably receivable over said first end of said stirrer, said sleeve having a length which is less than said length of said stirrer, and said stirrer has a sleeve removably received over said first end thereof and said second end of said stirrer is uncovered;
wherein said sleeve is received over said first end of said stirrer, whereby said stirrer having said sleeve received thereon can be selected by grasping said sleeve received over said first end thereof and said uncovered second end of said stirrer can be placed into a beverage, while holding said sleeve received over said first end of said stirrer, and whereby removal of said sleeve in covering relation on said first end makes accessible a hygienically constituted stirrer end.

14. The stirrer according to claim 13, wherein:
said sleeve has indicia imprinted thereon.

15. The stirrer according to claim 13, wherein:
said sleeve has a closed end.

16. The stirrer according to claim 13, wherein:
said sleeve has two open ends.

17. The stirrer according to claim 13, wherein:
said stirrer is a hollow straw.

18. The stirrer according to claim 13, wherein:
said stirrer is solid.

19. The assembly according to claim 1, wherein:
said plurality of sleeves are made of a material selected from the group consisting of paper and plastic.

20. The stirrers according to claim 7, wherein:
said plurality of sleeves are made of a material selected from the group consisting of paper and plastic.

21. The stirrer according to claim 13, wherein:
said sleeve is made of a material selected from the group consisting of paper and plastic.
